(19) United States
(12) Patent Application Publication
(10) Pub. No.: US 2005/0247069 A1
(43) Pub. Date: Nov. 10, 2005

(54) Air conditioning system charging apparatus

(76) Inventor: Newton Howard Dudley, Blum, TX (US)

Correspondence Address: KONNEKER & SMITH P. C., 660 NORTH CENTRAL EXPRESSWAY, SUITE 230, PLANO, TX, 75074, US

(21) Appl. No.: 10/841,149

(22) Filed: May 7, 2004

(51) Int. Cl. F25B 45/00; B60H 1/32

(52) U.S. Cl. 62/77; 62/292

(57) ABSTRACT

An air conditioning system charging apparatus. In a described embodiment, an air conditioning system charging apparatus includes a flexible conduit, a quick connect connector attached to one end of the conduit and a coupler attached to an opposite end of the conduit. The coupler includes a check valve which prevents pressure in the conduit from escaping. The quick connect connector does not include a valve.

### BACKGROUND

The present invention relates generally to air conditioning systems and, in an embodiment described herein, more particularly provides charging apparatus and methods for air conditioning systems.

Typical automotive air conditioning refrigerant charging tools use a complicated arrangement of interchanging valves and gauges, or an expensive and complex manifold device which is difficult for an untrained user to operate. In most of those tools which include a quick disconnect fitting at an end of a refrigerant charging hose, a valve is used in the fitting to prevent escape of refrigerant from the hose when the fitting is not connected to a charging port of an air conditioning system. The valve is opened when the fitting is connected to the charging port.

It would be beneficial to be able to provide an air conditioning charging tool which is convenient to use, uncomplicated to operate and economical to produce.

### SUMMARY

In carrying out the principles of the present invention, in accordance with an embodiment thereof, an air conditioning system charging apparatus is provided which achieves these desired benefits. The apparatus is relatively straightforward to understand and use, and economical to produce.

In one aspect of the invention, an air conditioning system charging apparatus is provided. The apparatus includes a flexible conduit, a quick connect connector attached to one end of the conduit and a coupler attached to an opposite end of the conduit. The coupler includes a check valve which prevents pressure in the conduit from escaping. The quick connect connector preferably does not include a valve.

In another aspect of the invention, a method of charging an air conditioning system is provided. The method includes the step of connecting a quick connect connector to a service port of the air conditioning system. This connecting step does not result in opening any valve in the connector.

These and other features, advantages, benefits and objects of the present invention will become apparent to one of ordinary skill in the art upon careful consideration of the detailed description of a representative embodiment of the invention hereinbelow and the accompanying drawing.

### BRIEF DESCRIPTION OF THE DRAWING

FIG. 1 is a schematic view of an air conditioning system charging apparatus and method embodying principles of the present invention.

### DETAILED DESCRIPTION

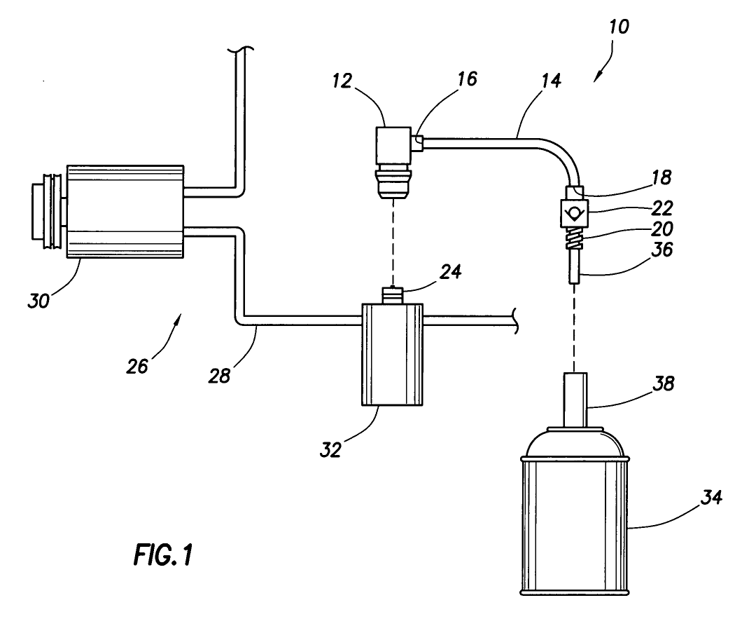

Representatively illustrated in FIG. 1 is an air conditioning system charging apparatus lo which embodies principles of the present invention. In the following description of the apparatus 10 and other embodiments of the invention, directional terms, such as “above”, “below”, “upper”, “lower”, etc., are used for convenience in referring to the accompanying drawings.

Additionally, it is to be understood that the embodiment of the invention described herein may be utilized in various orientations, such as inclined, inverted, horizontal, vertical, etc., and in various configurations, without departing from the principles of the invention. The embodiment is only an example of a particular application of the invention, and does not limit the scope of the invention.

As depicted in FIG. 1, the apparatus 10 includes a quick connect connector 12 attached at one end 16 of a flexible conduit or hose 14. At an opposite end 18 of the hose 14, a threaded coupler 20 is attached. The coupler 20 has a check valve 22 therein. The check valve 22 permits fluid flow through the coupler 20 in only one direction (i.e., upwardly as viewed in FIG. 1).

The quick connect connector 12 is of conventional design, except that it does not include a check valve or other valve which opens when the connector is connected to a low side service port 24 of an air conditioning system 26. The service port 24 could, for example, be located on an accumulator 32 or other device of the system 26. Connecting the connector 12 to the port 24 does open a valve (not visible in FIG. i) in the port 24, so that the hose 14 is placed in fluid communication with a low side line 28 of the system 26, upstream of a compressor 30.

Preferably, the connector 12 is otherwise a typical R-134a (1,1,1,2-tetrafluoroethane) air conditioning system quick connect connector of the type well known to those skilled in the art. When the connector 12 is connected to the service port 24, pressure in the line 28 is communicated to the hose 14. However, in the system 10, the check valve 22 prevents this pressure from escaping from the coupler 20 at the end 18 of the hose 14.

The coupler 20 is configured for connecting to a container 34 of a substance for dispensing into the air conditioning system 26. For example, the container 34 may contain refrigerant, lubricant, leak detector or another substance or combination of substances. The coupler 20 is externally threaded and includes a downwardly extending (as depicted in FIG. 1) tubular prong 36 for engagement with a valve 38 on the container 34. When the coupler 20 is connected to the container 34, the valve 38 is opened by the prong 36, and the substance can flow from the container, through the check valve 22 in the coupler, through the hose 14 and through the connector 12 into the service port 24 of the air conditioning system 26.

Note that it is not necessary for the coupler 20 to connect to the container 34 by threading. Other types of connecting means may be used, such as clamping, collets, etc.

When the charging operation is completed, the container 34 may be unthreaded or otherwise disconnected from the coupler 20. Withdrawal of the prong 36 from the valve 38 closes it. Again, the check valve 22 will prevent pressure in the hose 14 (which remains in communication with the line 28 via the service port 24) from escaping when the coupler 20 is disconnected from the container 34.

Another container of the same or a different substance could now be connected to the coupler 20 to further charge the air conditioning system 26, or the connector 12 can be disconnected from the service port 24 to discontinue the charging operation. When the connector 12 is disconnected from the service port 24, the valve in the service port is closed, thereby preventing pressure in the line 28 from escaping from the port.

Of course, a person skilled in the art would, upon a careful consideration of the above description of representative embodiments of the invention, readily appreciate that many modifications, additions, substitutions, deletions, and other changes may be made to these specific embodiments, and such changes are contemplated by the principles of the present invention. Accordingly, the foregoing detailed description is to be clearly understood as being given by way of illustration and example only, the spirit and scope of the present invention being limited solely by the appended claims and their equivalents.

1. An air conditioning system charging apparatus, comprising:
a flexible conduit having first and second opposite ends;
a quick connect connector attached at the first end of the conduit; and
a coupler attached at the second end of the conduit, the coupler including a check valve.

2. The apparatus according to claim 1, wherein the check valve permits fluid flow into the second end of the conduit, but prevents fluid flow out of the second end of the conduit.

3. The apparatus according to claim 1, wherein the quick connect connector is free of any valve which opens when the connector is connected to a service port of an air conditioning system.

4. The apparatus according to claim 1, wherein the quick connect connector is configured for operative connection to a service port of an R-134a air conditioning system.

5. The apparatus according to claim 1, wherein the coupler is configured for operative connection to a container of a substance for dispensing into an air conditioning system.

6. The apparatus according to claim 5, wherein a valve of the container is opened, thereby permitting the substance to flow through the check valve into the conduit, when the coupler is connected to the container.

7. The apparatus according to claim 5, wherein a tubular prong formed on the coupler opens a valve of the container, thereby permitting the substance to flow through the check valve into the conduit, when the coupler is connected to the container.

8. The apparatus according to claim 1, wherein the conduit is free of any check valve between the connector and the coupler.

9. The apparatus according to claim 1, wherein the connector opens a valve in a service port of an air conditioning system when the connector is connected to the service port, thereby permitting fluid communication between the conduit and a refrigerant line of the air conditioning system, without opening any valve in the connector.

10. The apparatus according to claim 1, further comprising a container of a substance for dispensing into the air conditioning system, a valve of the container being opened when the coupler is operatively connected to the valve.

11. A method of charging an air conditioning system, the method comprising the step of:
connecting a quick connect connector to a service port of the air conditioning system, without opening any valve in the connector.

12. The method according to claim 11, further comprising the step of attaching a first end of a flexible conduit to the connector, and wherein the connecting step further comprises providing fluid communication between the service port and the conduit.

13. The method according to claim 12, further comprising the step of attaching a coupler to a second end of the conduit, and wherein the connecting step further comprises preventing pressure in the conduit from escaping through the coupler.

14. The method according to claim 13, wherein the preventing step further comprises utilizing a check valve in the coupler to prevent pressure in the conduit from escaping.

15. The method according to claim 13, further comprising the step of connecting the coupler to a container of a substance for dispensing into the air conditioning system.

16. The method according to claim 15, wherein the step of connecting the coupler further comprises opening a valve of the container, thereby permitting the substance to flow through the check valve into the conduit.

17. The method according to claim 16, wherein the step of connecting the coupler further comprises threading the coupler to the container.

18. The method according to claim 16, wherein the step of opening the valve further comprises inserting a tubular prong formed on the coupler into the valve.
